(19) United States
(12) Patent Application Publication
(10) Pub. No.: US 2012/0306818 A1
(43) Pub. Date: Dec. 6, 2012

(54) SMALL-SIZED INPUT DEVICE

(75) Inventors: Toru Mizutani, Ibaraki-shi (JP); Yusuke Shimizu, Ibaraki-shi (JP)

(73) Assignee: NITTO DENKO CORPORATION, Osaka (JP)

(21) Appl. No.: 13/465,165

(22) Filed: May 7, 2012

Related U.S. Application Data
(60) Provisional application No. 61/495,126, filed on Jun. 9, 2011.

(30) Foreign Application Priority Data
Jun. 1, 2011 (JP) 2011-123208

(51) Int. Cl. G06F 3/042

(52) U.S. Cl. 345/175

(57) ABSTRACT

A small-sized input device is provided which includes: a rectangular frame-shaped optical waveguide having a rectangular hollow input-use interior that is not more than 10 cm in length and not more than 10 cm in width; and a control means provided on the outside of one of the sides of the optical waveguide. The optical waveguide and the control means are provided on the front surface of a rectangular frame-shaped retainer plate having the hollow input-use interior, and are covered with a rectangular frame-shaped protective plate. The control means includes: a light-emitting element connected to ends of light-emitting cores of the optical waveguide; a light-receiving element connected to ends of light-receiving cores of the optical waveguide; and an optical sensor for recognizing the amount (or distance) of movement of the small-sized input device.

### RELATED APPLICATIONS

This application claims the benefit of U.S. Provisional Application No. 61/495,126 filed on Jun. 9, 2011, which is hereby incorporated by reference.

### FIELD OF THE INVENTION

The present invention relates to a small-sized input device including an optical position detection means.

### BACKGROUND OF THE INVENTION

Conventionally, an optical position detection device (as disclosed in, for example, Japanese Patent No. 3682109) including a plurality of light-emitting elements and a plurality of light-receiving elements is proposed as an input device. This optical position detection device is in the form of a rectangular frame comprised of a pair of L-shaped sections. The light-emitting elements are disposed in juxtaposition in one of the L-shaped sections of the rectangular frame, and the light-receiving elements opposed to the light-emitting elements are disposed in juxtaposition in the other L-shaped section thereof. The rectangular frame-shaped optical position detection device is placed along the periphery of a rectangular display. Information such as a character is inputted to the optical position detection device and is caused to appear on the rectangular display by moving a pen, a finger or the like within the rectangular frame of the optical position detection device. Specifically, when a pen, a finger or the like is moved within the rectangular frame, some light beams emitted from the light-emitting elements are intercepted by the pen, the finger or the like. The light-receiving elements opposed to the light-emitting elements sense the interception of light beams to thereby detect the path of the pen, the finger or the like (input information such as a character). The path is outputted as a signal to the rectangular display.

However, the rectangular frame-shaped optical position detection device, which is placed along the periphery of the display, has a wide area within the rectangular frame. For this reason, when a user makes an attempt to input a character and the like within the rectangular frame with the pen or the like, not only the tip of the pen or the like but also a little finger of his/her hand that holds the pen or the like, the base of the little finger (such as a hypothenar) and the like come into contact with the surface of the display within the rectangular frame. In this case, the optical position detection device detects all of the parts in contact with the surface of the display within the rectangular frame to present a problem in that unnecessary objects (detection information about the little finger and the base thereof) are displayed on the display. When the user makes an attempt to input a character and the like with the pen so as not to bring the little finger and the base thereof into contact with the surface of the display, another problem arises in that the character and the like become messy and the user cannot properly perform the input operation.

### SUMMARY OF THE INVENTION

A small-sized input device is provided which allows a user to properly input information such as a character thereto with a pen or the like without detecting a little finger of his/her hand that holds the pen or the like, the base of the little finger, and the like.

The small-sized input device allows for moving over a predetermined region, stopping in a desired position within the predetermined region, and then inputting information thereto in the desired position. The small-sized input device comprises: a frame-shaped plate including a hollow input-use interior having a length of not more than 10 cm and a width of not more than 10 cm, and sections opposed to each other around the hollow input-use interior; a light-emitting means provided on one of the opposed sections of the frame-shaped plate; a light-receiving means provided on the other of the opposed sections of the frame-shaped plate and for receiving light emitted from the light-emitting means; and a movement amount recognizing means provided on the frame-shaped plate.

The small-sized input device is in the shape of a frame, and the hollow input-use interior within the frame is as small as not more than 10 cm in length and not more than 10 cm in width. When a user inputs information such as a character into the region within the hollow input-use interior with a pen or the like, the small hollow input-use interior allows a little finger of his/her hand that holds the pen or the like, the base of the little finger and the like to come into contact with the surface of the small-sized input device or the outside thereof, thereby preventing the little finger, the base thereof and the like to enter the hollow input-use interior. This allows the proper detection of the inputted information such as a character, and prevents the detection of unnecessary objects. Additionally, the small-sized input device, which is small in size, is excellent in portability, and provides a wide range of choice of places where the small-sized input device is used. Further, the small-sized input device includes the movement amount recognizing means. Even when the small-sized input device is moved, the movement amount recognizing means is capable of recognizing the position of the small-sized input device after the movement, so that the user can input new information in a desired position with respect to the previously inputted information. Thus, although the hollow input-use interior is small as mentioned above, the small-sized input device is able to have an input region that is large and unfixed because the small-sized input device includes the movement amount recognizing means.

Preferably, the light-emitting means includes a light-emitting element, and a plurality of light-emitting cores of an optical waveguide, the light-emitting cores being connected to the light-emitting element; the light-receiving means includes a light-receiving element, and a plurality of light-receiving cores of the optical waveguide, the light-receiving cores being connected to the light-receiving element; and tips of the light-emitting cores and tips of the light-receiving cores are opposed to each other while being positioned on inner edges of the frame-shaped plate. In such a case, the optical waveguide is formed on the frame-shaped plate, and is made thin. Thus, when a user performs an input operation with a pen or the like, the small-sized input device does not serve as an impediment to the input operation, but the user's hand that holds the pen or the like is allowed to be positioned in a natural position. This makes it easy to perform the input operation.

Preferably, the light-emitting means includes a plurality of light-emitting elements; the light-receiving means includes a plurality of light-receiving elements; and the light-emitting elements and the light-receiving elements are opposed to each other while being positioned on inner edges of the frame-shaped plate. In such a case, the light-emitting elements and the light-receiving elements have a certain amount of thickness, and the small-sized input device accordingly has a certain amount of thickness as a whole. This allows the small-sized input device to have a certain amount of rigidity and strength.

Preferably, the movement amount recognizing means is an optical sensor for reading the reflection of light emitted from the back surface of the frame-shaped plate to recognize the amount of movement of the small-sized input device. In such a case, the amount of movement is recognized with high accuracy, so that the input of the information after the movement of the small-sized input device is done in a higher-accuracy position. Examples of the light emitted from and read by the optical sensor include LED (light-emitting diode) light, and laser light.

### BRIEF DESCRIPTION OF THE DRAWINGS

FIG. 1 is a view schematically illustrating a small-sized input device according to a first preferred embodiment.

FIG. 2A is a plan view schematically showing an optical waveguide for the small-sized input device.

FIG. 2B is a sectional view, on an enlarged scale, taken along the line X1-X1 of FIG. 2A.

FIG. 2C is a sectional view, on an enlarged scale, taken along the line X2-X2 of FIG. 2A.

FIG. 3 is a view illustrating an example of movement of the small-sized input device.

FIGS. 4A to 4C, 5A to 5C, 6A, 6B, 7A and 8 are views schematically illustrating an exemplary method of producing the small-sized input device.

FIG. 7B is a sectional view taken along the line X4-X4 of FIG. 7A.

FIG. 9 is a view schematically illustrating the small-sized input device according to a second preferred embodiment.

### DETAILED DESCRIPTION OF THE INVENTION

Preferred embodiments according to the present invention will now be described in detail with reference to the drawings.

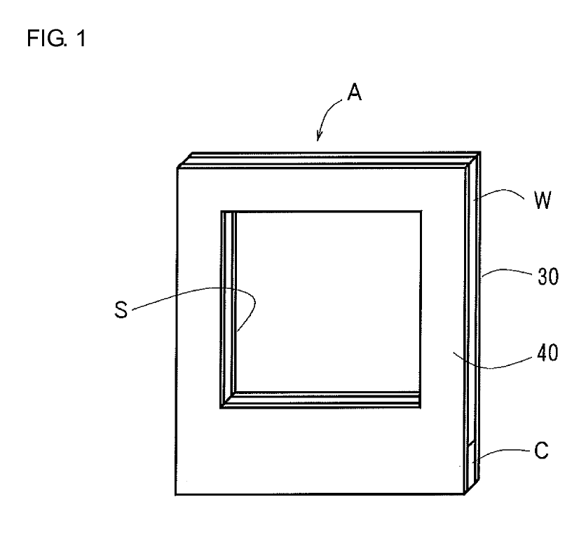

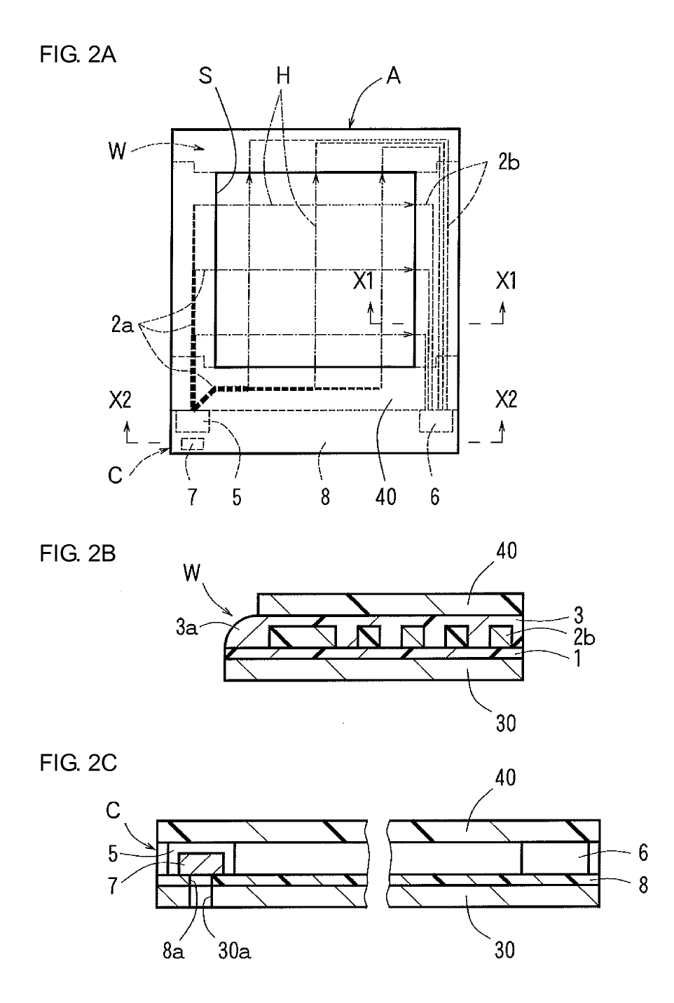

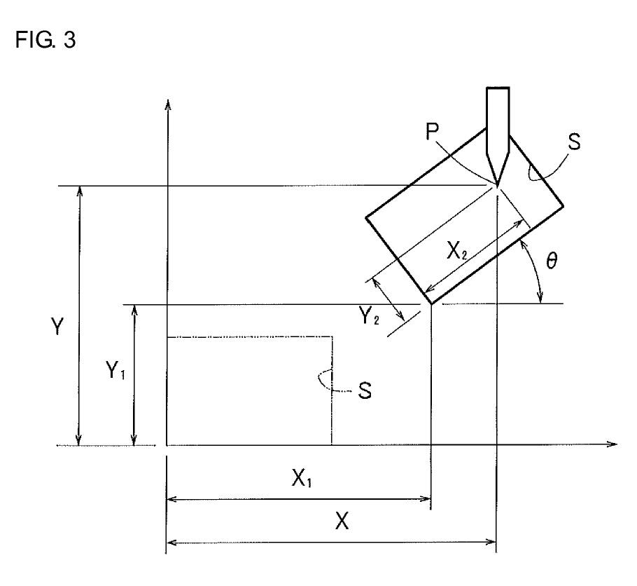

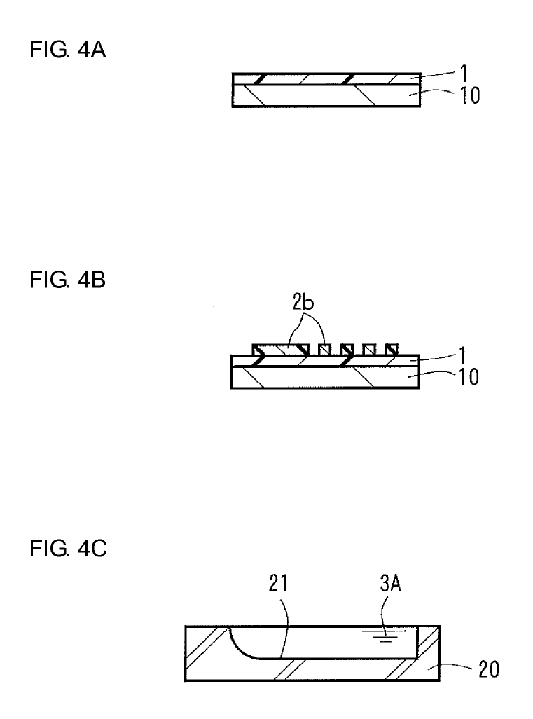

FIG. 1 is a perspective view showing a small-sized input device according to a first preferred embodiment. FIG. 2A is a plan view of the small-sized input device A. FIG. 2B is a sectional view, on an enlarged scale, taken along the line X1-X1 of FIG. 2A. FIG. 2C is a sectional view, on an enlarged scale, taken along the line X2-X2 of FIG. 2A. As shown in FIGS. 1, 2A, 2B and 2C, the small-sized input device A according to the first preferred embodiment includes: a rectangular frame-shaped optical waveguide W having a rectangular hollow input-use interior (window) S that is not more than 10 cm in length and not more than 10 cm in width; and a control means C provided on the outside of one of the four sides of the optical waveguide W. The optical waveguide W and the control means C are provided on the front surface of a rectangular frame-shaped retainer plate (frame-shaped plate) 30 having the hollow input-use interior S, and are covered with a rectangular frame-shaped protective plate 40. The control means C includes: a light-emitting element 5 connected to ends of light-emitting cores 2a of the optical waveguide W; a light-receiving element 6 connected to ends of light-receiving cores 2b of the optical waveguide W; and an optical sensor 7 for recognizing the amount (or distance) of movement of the small-sized input device A.

The optical sensor 7 is configured to emit light and to read the reflected light, thereby recognizing the amount of movement of the small-sized input device A. For recognition of the amount of movement, as shown in FIG. 2C, through holes 8a and 30a are formed in part of a circuit board 8 on which the optical sensor 7 is mounted and in part of the retainer plate 30 corresponding to the position where the optical sensor 7 is provided, respectively. The optical sensor 7 emits light through the through holes 8a and 30a outwardly from the back surface of the retainer plate 30 to read the reflected light. The single optical sensor 7, as shown, is capable of recognizing an angle through which the small-sized input device A is rotated. To improve the recognition accuracy of the angle, two optical sensors 7 may be used and disposed in a spaced apart relationship to calculate the angle from a difference between the values of the amount of movement recognized by the respective optical sensors 7.

The control means C further includes an integrated circuit (IC) (not shown) for controlling the small-sized input device A, an output module (not shown) for outputting information inputted to a region within the hollow input-use interior S of the optical waveguide W (information about the movement path of a pen tip and the like), a battery (not shown) serving as a power source, and the like. The light-emitting element 5, the light-receiving element 6, the optical sensor 7, the IC, the output module, the battery and the like are mounted on the circuit board 8, and are electrically connected to each other.

The rectangular frame-shaped optical waveguide W will be described in further detail. As shown in FIGS. 2A and 2B, the rectangular frame-shaped optical waveguide W is configured such that four strip-shaped optical waveguide sections corresponding to the respective sides of the rectangular frame shape of the optical waveguide W are produced individually and then connected together into the shape of the rectangular frame. In the first preferred embodiment, opposite end edges of each of the strip-shaped optical waveguide sections have step portions. Adjacent ones of the optical waveguide sections, which are positioned relative to each other using the step portions, are connected to each other. Each of the strip-shaped optical waveguide sections includes an under cladding layer 1, the cores 2a and 2b formed in a predetermined pattern on a surface of the under cladding layer 1, and an over cladding layer 3 formed on the surface of the under cladding layer 1 so as to cover the cores 2a and 2b. The under cladding layer 1 is affixed to the front surface of the rectangular frame-shaped retainer plate 30. In the rectangular frame-shaped optical waveguide W, the under cladding layer 1 is in the shape of a rectangular frame comprised of a pair of L-shaped sections. The light-emitting cores 2a are disposed in a divided manner on the surface of one of the L-shaped sections, and the light-receiving cores 2b are disposed in juxtaposition on the surface of the other L-shaped section. The cores 2a and 2b have respective tips positioned on the inner edges of the pair of L-shaped sections (the inner peripheral edges of the rectangular frame). The tips of the light-emitting cores 2a are in an opposed relationship to the tips of the light-receiving cores 2b. The over cladding layer 3 in the shape of a rectangular frame is formed on the surface of the under cladding layer 1 so as to cover the light-emitting cores 2a and the light-receiving cores 2b. In the first preferred embodiment, each of the tips of the cores 2a and 2b positioned on the inner peripheral edges of the rectangular frame is in the form of a convex lens portion having a substantially semicircular curved surface as seen in plan view, and an edge portion of the over cladding layer 3 covering the lens portions is in the form of a convex lens portion 3a having a substantially quadrantal curved surface as seen in sectional side view. In FIG. 2A, the cores 2a and 2b are indicated by broken lines, and the thickness of the broken lines indicates the width of the cores 2a and 2b. Also, in FIGS. 2A and 2B, the number of cores 2a and 2b are shown as abbreviated.

In the small-sized input device A, light beams H from the light-emitting element 5 pass through the light-emitting cores 2a and through the lens portions at the tips of the respective light-emitting cores 2a, and then exit the surface of the lens portion 3a of the over cladding layer 3 covering the lens portions at the tips of the respective light-emitting cores 2a. The exit of the light beams H causes the light beams H to travel in a lattice form in the region within the hollow input-use interior S of the rectangular frame-shaped optical waveguide W. The light beams H traveling in a lattice form are restrained from diverging by refraction through the lens portions at the tips of the light-emitting cores 2a and through the lens portion 3a of the over cladding layer 3 covering the lens portions at the tips of the light-emitting cores 2a. In this state, information such as a character, a drawing and a mark is inputted to the small-sized input device A by moving a pen or the like in the region within the hollow input-use interior S of the optical waveguide W. Specifically, when a user moves the pen or the like in the region within the hollow input-use interior S of the optical waveguide W, some of the light beams H traveling in the lattice form are intercepted by the tip of the pen or the like. The light-receiving element 6 senses the interception of light beams to thereby detect the path of the tip of the pen or the like (input information such as a character).

Such a small-sized input device A is used together with, for example, a personal computer. Specifically, when information such as a document is displayed on a display for the personal computer and a user wants to add information such as a character, a drawing or a mark to the displayed information, the user places the small-sized input device A on a table or on a paper sheet or the like on the table, and then inputs the information such as a character into the region within the hollow input-use interior S of the small-sized input device A with a pen or the like. In response to this input operation, the small-sized input device A detects the path of the tip of the pen or the like, and transmits the path as a signal to the personal computer by radio or through a connecting cable, so that the inputted information appears on the display. The information such as a character inputted by means of the small-sized input device A which is superimposed on the information such as a document appears on the display.

When the small-sized input device A is slidably moved on the table or the like, the amount of movement of the small-sized input device A is recognized by the optical sensor 7, and is also transmitted to the personal computer by radio or through the connecting cable. The position of the hollow input-use interior S after the movement also appears on the display. In the new position after the movement, the user may input information such as a character with the pen or the like in the aforementioned manner.

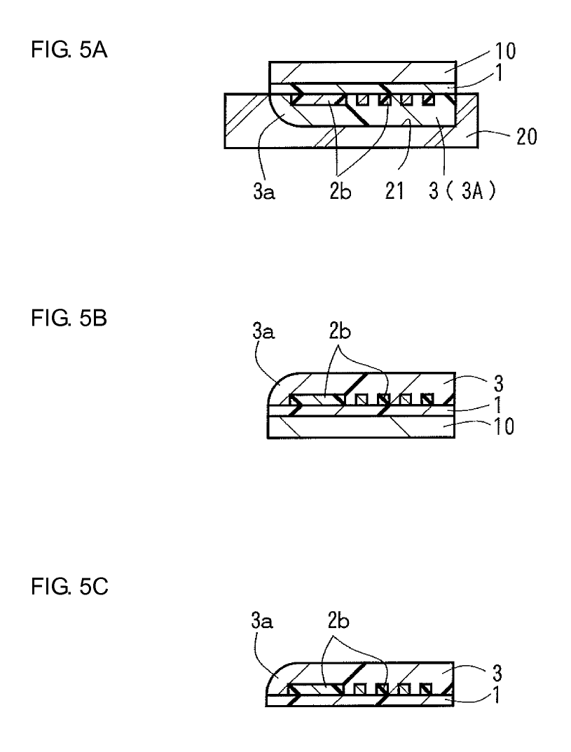

For example, when the coordinates at the position of the tip of the pen in the hollow input-use interior S of the small-sized input device A is represented as X₂ and Y₂, and when the hollow input-use interior S of the small-sized input device A is translated a distance X₁ in a first direction and a distance Y₁ in a second direction orthogonal to the first direction and is then rotated through an angle e as shown in FIG. 3, the coordinates X (in the first direction) and Y (in the second direction) at the position P of the tip of the pen after the movement are recognized as:

X=X₂ cos θ−Y₂ sin θ+X₁ (1)

Y=X₂ sin θ+Y₂ cos θ+Y₁ (2)

The inputted information appears on the display in corresponding relation to the coordinates X and Y. Thus, the user may input new information in the new position after the movement. Although the hollow input-use interior S itself of the small-sized input device A is small, the combination of the hollow input-use interior S with the optical sensor (movement amount recognizing means) 7 allows the efficient use of the entire screen of the display.

The personal computer used herein will be described. At the beginning of the use of the small-sized input device A and the like, a display part of the display corresponding to the hollow input-use interior S of the small-sized input device A is adapted to be positioned in a predetermined reference position on the display (or to be reset) by user's manipulation of a switch on the small-sized input device A or user's manipulation of a keyboard for the personal computer. Also, software (a program) which converts coordinates in the region within the hollow input-use interior S of the small-sized input device A into coordinates on the screen of the display to display a character or the like inputted by means of the small-sized input device A is incorporated in the personal computer for the purpose of displaying the character or the like inputted in the hollow input-use interior S of the small-sized input device A in a position on the display corresponding to the input position.

It should be noted that the information such as a document is, in general, previously stored in an information storage medium such as a hard disk in the personal computer or an external USB memory device, and is outputted from the information storage medium. The information appearing on the display which is the superimposition of the information such as a character inputted by means of the small-sized input device A on the information such as a document may be stored in the information storage medium.

For the use of the small-sized input device A in this manner, the hollow input-use interior S of the small-sized input device A is as small as not more than 10 cm in length and not more than 10 cm in width. When a user inputs information such as a character into the region within the hollow input-use interior S with a pen or the like in the aforementioned manner, the small hollow input-use interior S allows a little finger of his/her hand that holds the pen or the like, the base of the little finger and the like to come into contact with the surface of the small-sized input device A or the outside thereof, thereby preventing the detection of the little finger and the like within the hollow input-use interior S.

In particular, the optical waveguide W of the small-sized input device A is made thin (with a thickness, at most, of approximately 2 mm). Even when the retainer plate 30 and the protective plate 40 are provided on the front and back surfaces of the optical waveguide W as in the first preferred embodiment, the total thickness of the optical waveguide W is approximately 3 mm. Thus, when the user performs an input operation with a pen or the like, the small-sized input device A does not serve as an impediment to the input operation, but the user's hand that holds the pen or the like is allowed to be positioned in a natural position. This makes it easy to perform the input operation.

Additionally, the small-sized input device A, which is small in size, is excellent in portability, and provides a wide range of choice of places where the small-sized input device A is used.

Further, even when the small-sized input device A is slidably moved on the table or the like, the position of the small-sized input device A after the movement is recognized because the small-sized input device A includes the optical sensor 7 for recognizing the amount of movement. This allows new information to be inputted into a desired position with respect to the previously inputted information for the information appearing on the display. Thus, although the hollow input-use interior S is small as mentioned above, the small-sized input device A may have an input region that is large and unfixed because the small-sized input device A includes the optical sensor 7 for recognizing the amount of movement as mentioned earlier.

Moreover, the user may draw a straight line by moving the pen tip along an inner edge of the hollow input-use interior S of the small-sized input device A. When the user draws another straight line in a similar manner after moving the small-sized input device A, he/she is able to know the distance between the straight lines before and after the movement. In this manner, the small-sized input device A may be used as a ruler.

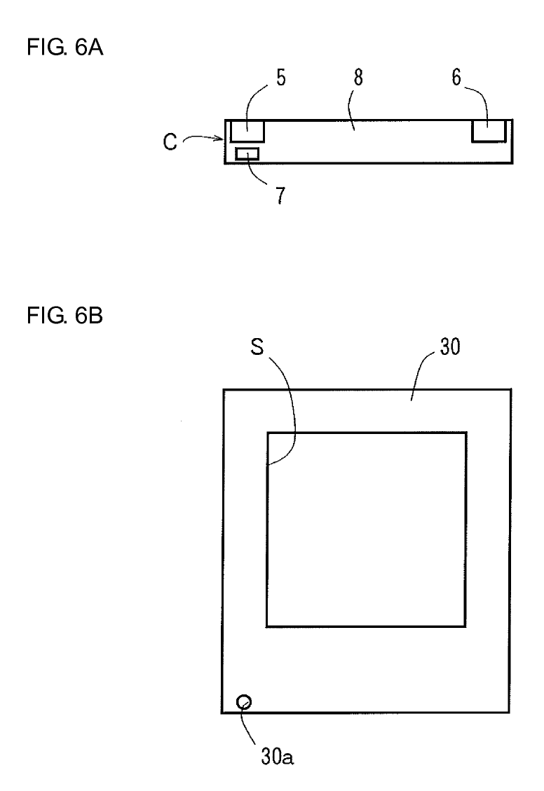

Next, an exemplary method of producing the small-sized input device A will be described. In the first preferred embodiment, the rectangular frame-shaped optical waveguide W is produced by individually producing the strip-shaped optical waveguide sections corresponding to the respective sides of the rectangular frame shape of the optical waveguide W and then connecting the strip-shaped optical waveguide sections together into the shape of the rectangular frame. It should be noted that FIGS. 4A to 4C, and 5A to 5C cited for description on the method of producing the optical waveguide W show portions corresponding to a cross section taken along the line X1-X1 of FIG. 2A.

First, a substrate 10 for the formation of each of the strip-shaped optical waveguide sections (with reference to FIG. 4A) is prepared. Examples of a material for the formation of this substrate 10 include metal, resin, glass, quartz, and silicon.

Then, as shown in FIG. 4A, the strip-shaped under cladding layer 1 is formed on a surface of the substrate 10. This under cladding layer 1 may be formed by a photolithographic method using a photosensitive resin as a material for the formation thereof. The under cladding layer 1 has a thickness in the range of 5 to 50 μm, for example.

Next, as shown in FIG. 4B, the light-emitting cores 2a and the light-receiving cores 2b which have the aforementioned pattern are formed on a surface of the under cladding layer 1 by a photolithographic method. An example of a material for the formation of the cores 2a and 2b used herein includes a photosensitive resin having a refractive index higher than that of the materials for the formation of the under cladding layer 1 and the over cladding layer 3 to be described below (with reference to FIG. 5B).

As shown in FIG. 4C, a light-transmissive mold 20 for the formation of the over cladding layer 3 is prepared. The mold 20 includes a cavity 21 having a mold surface complementary in shape to the surface of the over cladding layer 3 (with reference to FIG. 5B). The mold 20 is placed on a molding stage (not shown), with the cavity 21 positioned to face upward. Then, the cavity 21 is filled with a photosensitive resin 3A serving as the material for the formation of the over cladding layer 3.

Then, as shown in FIG. 5A, the cores 2a and 2b patterned on the surface of the under cladding layer 1 are positioned relative to the cavity 21 of the mold 20. In that state, the under cladding layer 1 is pressed against the mold 20, so that the cores 2a and 2b are immersed in the photosensitive resin 3A serving as the material for the formation of the over cladding layer 3. In this state, the photosensitive resin 3A is exposed to irradiation light such as ultraviolet light by directing the irradiation light through the mold 20 onto the photosensitive resin 3A. This exposure cures the photosensitive resin 3A to form the over cladding layer 3 in which part of the over cladding layer 3 corresponding to the tips of the cores 2a and 2b is formed as the lens portion 3a.

Next, as shown in FIG. 5B (shown in an orientation vertically inverted from that shown in FIG. 5A), the over cladding layer 3 together with the substrate 10, the under cladding layer 1, and the cores 2a and 2b is removed from the mold 20 (with reference to FIG. 5A).

Then, as shown in FIG. 5C, the substrate 10 (with reference to FIG. 4B) is stripped from the under cladding layer 1. This provides each of the strip-shaped optical waveguide sections including the under cladding layer 1, the cores 2a and 2b, and the over cladding layer 3.

Next, as shown in plan view in FIG. 6A, the circuit board 8 is prepared, and the control means C is produced by mounting on the circuit board 8 the following parts: the light-emitting element 5; the light-receiving element 6; the optical sensor 7 for recognition of the amount of movement; the IC (not shown) for controlling the small-sized input device A (with reference to FIG. 1); the output module (not shown) for outputting information inputted into the region within the hollow input-use interior S of the optical waveguide W (with reference to FIG. 1); the battery; and the like. The through hole 8a (with reference to FIG. 2C) for passage of light therethrough is previously formed in part of the circuit board 8 on which the optical sensor 7 is to be mounted.

The rectangular frame-shaped retainer plate 30 having the hollow input-use interior S is prepared, as shown in plan view in FIG. 6B. Examples of a material for the formation of the retainer plate 30 include metal, resin, glass, quartz and silicon. In particular, stainless steel is preferable in that it has a good ability to hold its planarity. The retainer plate 30 has a thickness of approximately 0.5 mm, for example. The through hole 30a for passage of light therethrough is previously formed in part of the retainer plate 30 corresponding to the position where the optical sensor 7 is to be provided.

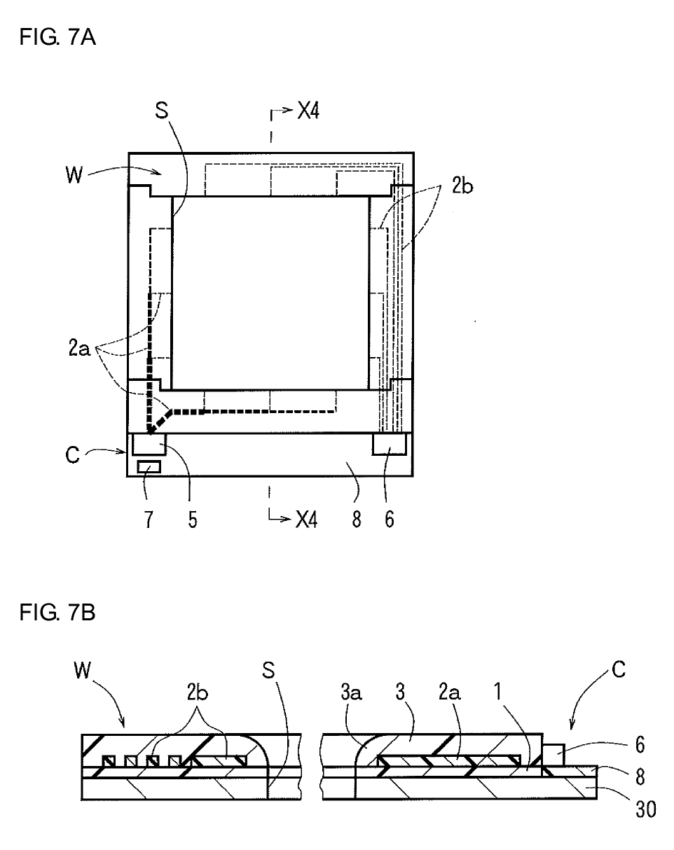

As shown in plan view in FIG. 7A and shown in sectional view (a sectional view taken along the line X4-X4 of FIG. 7A) in FIG. 7B, the strip-shaped optical waveguide sections are affixed to the front surface of the rectangular frame-shaped retainer plate 30 to produce the rectangular frame-shaped optical waveguide W. At this time, the light-emitting element 5 is connected to the light-emitting cores 2a, and the light-receiving element 6 is connected to the light-receiving cores 2b.

Thereafter, as shown in sectional view in FIG. 8, the top surface of the over cladding layer 3 except the lens portion 3a, and the control means C are covered with the protective plate 40. Examples of a material for the formation of the protective plate 40 include resin, metal, glass, quartz, and silicon. The protective plate 40 has a thickness of approximately 0.5 mm when made of metal, and approximately 0.8 mm when made of resin, for example. In this manner, the small-sized input device A is produced. Part of the small-sized input device A corresponding to the optical waveguide W, together with the retainer plate 30 and the protective plate 40 on the front and back surfaces thereof, is as thin as approximately 3 mm in total thickness, as mentioned above.

Part of the small-sized input device A corresponding to the control means C, together with the retainer plate 30 and the protective plate 40 on the front and back surfaces thereof, is as thin as approximately 3 mm in total thickness. In the first preferred embodiment, the part of the small-sized input device A corresponding to the optical waveguide W and the part of the small-sized input device A corresponding to the control means C are equal in thickness to each other.

For the purpose of improving the light transmission efficiency within the hollow input-use interior S of the rectangular frame-shaped optical waveguide W of the small-sized input device A according to the first preferred embodiment, the tips of the light-emitting cores 2a and the tips of the light-receiving cores 2b are formed as the lens portions, and the edge portion of the over cladding layer 3 covering the lens portions at the tips of the cores 2a and 2b is formed as the lens portion 3a. However, when the light transmission efficiency within the hollow input-use interior S is sufficient, the aforementioned lens portion(s) may be formed only in either the cores 2a and 2b or the over cladding layer 3, or be formed in neither the cores 2a and 2b nor the over cladding layer 3. When the aforementioned lens portions are not formed, a separate lens element may be prepared and provided along the peripheral edges within the hollow input-use interior S of the optical waveguide W.

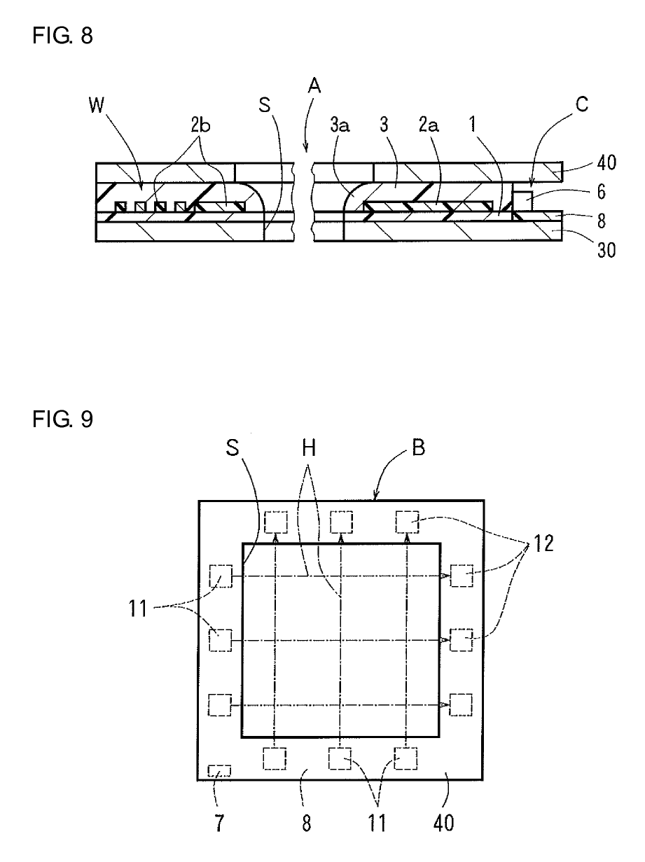

FIG. 9 shows a small-sized input device according to a second preferred embodiment. The small-sized input device B according to the second preferred embodiment includes: a rectangular frame-shaped retainer plate having a rectangular hollow input-use interior S that is not more than 10 cm in length and not more than 10 cm in width; light-emitting diodes (light-emitting means) 11 disposed in juxtaposition on one of opposed peripheral sections around the hollow input-use interior S; and photodiodes (light-receiving means) 12 disposed in juxtaposition on the other peripheral section. Light-emitting sections of the light-emitting diodes 11 are opposed to light-receiving sections of the photodiodes 12. The optical waveguide W (with reference to FIG. 1) is not provided in the small-sized input device B. It should be noted that the light-emitting diodes 11 and the photodiodes 12 are mounted on the rectangular frame-shaped circuit board 8 provided on the front surface of the retainer plate. As in the first preferred embodiment described above, the optical sensor 7 for recognizing the amount of movement, an IC for controlling the small-sized input device B, an output module for outputting information inputted into the region within the hollow input-use interior S, a battery, and the like are mounted on the circuit board 8. Further, the protective plate 40 is also provided. In FIG. 9, the number of light-emitting diodes 11 and the number of photodiodes 12 are shown as abbreviated.

Also in the second preferred embodiment, the light-emitting diodes 11 cause light beams H to travel in a lattice form in the region within the hollow input-use interior S. When a user moves a pen or the like in the region within the hollow input-use interior S and inputs information such as a character, some of the light beams H traveling in the lattice form are intercepted by the tip of the pen or the like. The photodiodes 12 sense the interception of light beams to thereby detect the path of the tip of the pen or the like (input information such as a character). In other words, the small-sized input device B according to the second preferred embodiment is used in a manner similar to that in the small-sized input device A according to the first preferred embodiment, and is similar in function and effect to the small-sized input device A according to the first preferred embodiment.

In the first and second preferred embodiments described above, the small-sized input devices A and B are used together with a personal computer, and the information inputted to the small-sized input devices A and B is displayed on a display for the personal computer. Alternatively, functionality similar to that of the personal computer in the first and second preferred embodiments may be imparted to the small-sized input devices A and B or to the display, so that information is displayed on the display without using the personal computer.

Although the optical sensor is used as the movement amount recognizing means in the first and second preferred embodiments, other components maybe used. For example, a ball-type sensor may be used as the movement amount recognizing means. Such a ball-type sensor is a sensor which senses the direction and amount of rotation of a ball in contact with a table or the like when the small-sized input device A is slidably moved on the table or the like, to recognize the amount of movement of the small-sized input device A. When in use, two such ball-type sensors are disposed in spaced apart relation to calculate the angle of the rotation from a difference between the values of the amount of movement recognized by the respective ball-type sensors.

Next, examples of the present invention will be described. It should be noted that the present invention is not limited to the examples.

### EXAMPLES

### Example 1

### <Material for Formation of Under Cladding Layer>

Component A: 75 parts by weight of an epoxy resin containing an alicyclic skeleton (EHPE 3150 available from Daicel Chemical Industries, Ltd.).

Component B: 25 parts by weight of an epoxy-group-containing acrylic polymer (MARPROOF G-0150M available from NOF Corporation).

Component C: four parts by weight of a photo-acid generator (CPI-200K available from San-Apro Ltd.).

A material for the formation of an under cladding layer was prepared by dissolving these components A to

C together with five parts by weight of an ultraviolet absorber (TINUVIN 479 available from Ciba Japan K.K.) in cyclohexanone (a solvent).

### <Material for Formation of Cores>

Component D: 85 parts by weight of an epoxy resin containing a bisphenol A skeleton (157S70 available from Japan Epoxy Resins Co., Ltd.).

Component E: five parts by weight of an epoxy resin containing a bisphenol A skeleton (EPIKOTE 828 available from Japan Epoxy Resins Co., Ltd.).

Component F: 10 parts by weight of an epoxy-group-containing styrenic polymer (MARPROOF G-0250SP available from NOF Corporation).

A material for the formation of cores was prepared by dissolving components D to F and four parts by weight of the aforementioned component C in ethyl lactate.

### <Material for Formation of Over Cladding Layer>

Component G: 100 parts by weight of an epoxy resin having an alicyclic skeleton (EP4080E available from ADEKA Corporation).

A material for the formation of an over cladding layer was prepared by mixing component G and two parts by weight of the aforementioned component C together.

### <Production of Optical Waveguide>

The material for the formation of the under cladding layer was applied to a surface of a substrate made of stainless steel (having a thickness of 50 μm). Thereafter, a heating treatment was performed at 160° C. for two minutes to form a photosensitive resin layer. Then, the photosensitive resin layer was exposed to irradiation with ultraviolet light at an integrated dose of 1000 mJ/cm². Thus, the under cladding layer having a thickness of 10 μm (with a refractive index of 1.510 at a wavelength of 830 nm) was formed.

Then, the material for the formation of the cores was applied to a surface of the under cladding layer. Thereafter, a heating treatment was performed at 170° C. for three minutes to form a photosensitive resin layer. Next, the photosensitive resin layer was exposed to irradiation with ultraviolet light at an integrated dose of 3000 mJ/cm² through a photomask (with a gap of 100 μm). Subsequently, a heating treatment was performed at 120° C. for 10 minutes. Thereafter, development was performed using a developing solution (γ-butyrolactone) to dissolve away unexposed portions. Thereafter, a drying process was performed at120° C. for five minutes. Thus, the cores having a width of 30 μm and a height of 50 μm (with a refractive index of 1.570 at a wavelength of 830 nm) were patterned.

A light-transmissive mold for the formation of the over cladding layer was prepared. This mold includes a cavity having a mold surface complementary in shape to the surface of the over cladding layer. The mold was placed on a molding stage, with the cavity positioned to face upward. Then, the cavity was filled with the material for the formation of the over cladding layer.

Then, the cores patterned on the surface of the under cladding layer were positioned relative to the cavity of the mold. In that state, the under cladding layer was pressed against the mold, so that the cores were immersed in the material for the formation of the over cladding layer. In this state, exposure was performed at an integrated dose of 8000 mJ/cm² by irradiating the material for the formation of the over cladding layer with ultraviolet light through the mold. Thus, the over cladding layer was formed in which a portion thereof corresponding to the tips of the cores was in the form of a convex lens portion. The convex lens portion had a substantially quadrantal curved lens surface (having a radius of curvature of 1.4 mm) as seen in sectional side view.

Next, the over cladding layer together with the substrate, the under cladding layer and the cores was removed from the mold.

Then, the substrate was stripped from the under cladding layer. This provided each strip-shaped optical waveguide section (having a total thickness of 1 mm) including the under cladding layer, the cores, and the over cladding layer.

### <Production of Small-Sized Input Device>

Next, a circuit board was prepared, and a control means was produced by mounting a light-emitting element (SM85-2N001 available from Optowell Co., Ltd.), a light-receiving element (S-10226 available from Hamamatsu Photonics K.K.), an optical sensor (ADNS-5050 available from Avago Technologies) for recognition of the amount of movement, a CMOS driving IC, a crystal oscillator, a wireless module, two coin-type lithium cells (CR1216 having a thickness of 1.6 mm, a diameter of 1.25 mm, and a voltage of 3 V) and the like onto the circuit board.

A rectangular frame-shaped retainer plate made of stainless steel (having a thickness of 0.5 mm) was prepared. The retainer plate had a hollow input-use interior in the form of a rectangle that was 10 cm in length and 10 cm in width. The strip-shaped optical waveguide sections were affixed to a portion of a surface of the retainer plate which was outside the hollow input-use interior to produce a rectangular frame-shaped optical waveguide, and the control means was fixed thereon. At this time, the light-emitting element was connected to light-emitting ones of the cores, and the light-receiving element was connected to light-receiving ones of the cores. Thereafter, the top surface of the over cladding layer except the lens portion and the fixed portion of the control means were covered with a rectangular frame-shaped protective plate made of stainless steel (having a thickness of 0.5 mm). This provided a small-sized input device. Part of the small-sized input device corresponding to the optical waveguide, together with the retainer plate and the protective plate on the front and back surfaces thereof, had a total thickness of 2 mm. Part of the small-sized input device where the control means was fixed, together with the retainer plate and the protective plate on the front and back surfaces thereof, had a total thickness of 3 mm.

### Example 2

### <Production of Small-Sized Input Device>

A rectangular frame-shaped retainer plate similar to that in Example 1 was prepared. Light-emitting diodes (GL4800E0000F available from Sharp Corporation) were disposed in juxtaposition on one of opposed peripheral sections around the hollow input-use interior, and photodiodes (PD411PI2E00P available from Sharp Corporation) were disposed in juxtaposition on the other peripheral section. Also, in a manner similar to that in Example 1, a control means was produced by mounting an optical sensor for recognizing the amount of movement, a CMOS driving IC, a crystal oscillator, a wireless module, two coin-type lithium cells and the like onto a circuit board, and the control means was fixed on the retainer plate. Then, the light-emitting diodes, the photodiodes and the control means were covered with a rectangular frame-shaped protective plate made of stainless steel (having a thickness of 0.5 mm). This provided a small-sized input device. The small-sized input device was uniform in thickness, and had a total thickness of 3 mm.

### <Operation Check of Small-Sized Input Device>

A USB memory device with information such as a document stored therein, and a personal computer were prepared. The information stored in the USB memory device was displayed on a display for the personal computer by the use of the personal computer. A display part of the display corresponding to the hollow input-use interior of the small-sized input device was adapted to be positioned in a predetermined reference position on the display by user's manipulation of a switch on the small-sized input device or user's manipulation of a keyboard for the personal computer. Also, software (a program) for converting coordinates in the region within the rectangular frame-shaped hollow input-use interior of the small-sized input device into coordinates on the screen of the display to display a character or the like inputted by means of the small-sized input device is incorporated in the personal computer. The personal computer included a receiving means so as to be able to receive radio waves (information) from the wireless module of the small-sized input device. The personal computer and the small-sized input device were connected for transmission of information therebetween by radio.

The small-sized input device in each of Examples 1 and 2 was placed in any position on a flat table, with the stainless steel retainer plate facing down. In this state, the display part of the display corresponding to the hollow input-use interior of the small-sized input device was positioned in the predetermined reference position on the display. Next, a pen tip was moved in the region within the hollow input-use interior. As a result, the path of movement of the pen tip was displayed while being superimposed on the information such as a document appearing on the display. Next, the small-sized input device was slidably moved on the table. In the position after the movement, the pen tip was moved in the region within the hollow input-use interior. As a result, the path of movement of the pen tip was displayed in a position spaced a distance corresponding to the amount of movement apart on the display in a manner similar to that described above.

A small-sized input device having a hollow input-use interior that was 10 cm in length and 5 cm in width, and a small-sized input device having a hollow input-use interior that was 5 cm in length and 5 cm in width were produced in each of Examples 1 and 2, and operation checks of the small-sized input devices were conducted in a manner similar to that described above. The results were similar to those described above.

The small-sized input device is applicable to the addition of new information such as characters, drawings, marks and the like to documents and the like appearing on a display.

Although specific forms of embodiments of the instant invention have been described above and illustrated in the accompanying drawings in order to be more clearly understood, the above description is made by way of example and not as a limitation to the scope of the instant invention. It is contemplated that various modifications apparent to one of ordinary skill in the art could be made without departing from the scope of the invention.

What is claimed is:

1. A small-sized input device, comprising:
a frame-shaped plate including a hollow input-use interior having a length of not more than 10 cm and a width of not more than 10 cm, and sections opposed to each other around the hollow input-use interior;
a light-emitting means provided on one of the opposed sections of the frame-shaped plate;
a light-receiving means provided on the other of the opposed sections of the frame-shaped plate and for receiving light emitted from the light-emitting means; and
a movement amount recognizing means provided on the frame-shaped plate.

2. The small-sized input device according to claim 1,
wherein the light-emitting means includes a light-emitting element, and a plurality of light-emitting cores of an optical waveguide, the plurality of light-emitting cores being connected to the light-emitting element;
wherein the light-receiving means includes a light-receiving element, and a plurality of light-receiving cores of the optical waveguide, the plurality of light-receiving cores being connected to the light-receiving element; and
wherein tips of the plurality of light-emitting cores and tips of the plurality of light-receiving cores are opposed to each other and are positioned on inner edges of the frame-shaped plate.

3. The small-sized input device according to claim 1,
wherein the light-emitting means includes a plurality of light-emitting elements;
wherein the light-receiving means includes a plurality of light-receiving elements; and
wherein the light-emitting elements and the light-receiving elements are opposed to each other and are positioned on inner edges of the frame-shaped plate.

4. The small-sized input device according to claim 1, wherein the movement amount recognizing means is an optical sensor for reading the reflection of light emitted from a back surface of the frame-shaped plate to recognize the amount of movement of the small-sized input device.

5. The small-sized input device according to claim 2, wherein the movement amount recognizing means is an optical sensor for reading the reflection of light emitted from a back surface of the frame-shaped plate to recognize the amount of movement of the small-sized input device.

6. The small-sized input device according to claim 3, wherein the movement amount recognizing means is an optical sensor for reading the reflection of light emitted from a back surface of the frame-shaped plate to recognize the amount of movement of the small-sized input device.
